(19) United States
(12) Patent Application Publication
(10) Pub. No.: US 2015/0279308 A1
(43) Pub. Date: Oct. 1, 2015

(54) SERVER AND METHOD FOR DISPLAYING SCREEN

(71) Applicant: DeNA Co., Ltd., Tokyo (JP)

(72) Inventor: Kazuho OKU, Tokyo (JP)

(73) Assignee: DeNA, Co., Ltd.

(21) Appl. No.: 14/667,667

(22) Filed: Mar. 24, 2015

(30) Foreign Application Priority Data
Mar. 25, 2014 (JP) 2014-062112

(51) Int. Cl. G09G 5/00; H04N 19/70; G06F 17/30; G06T 1/20; G06T 1/60

(52) U.S. Cl. CPC G09G 5/003; G06T 1/20; G06T 1/60; G06F 17/3028; H04N 19/70; G09G 2370/02

(57) ABSTRACT

According to one embodiment, it is possible to increase the compression rate of data size of an image file while reducing the number of requests for obtaining a plurality of images contained in a screen. The server may include a storage unit configured to store information, and a display control unit configured to, in response to a display request to display a screen from the terminal device, cause the terminal device to obtain an image file from one or more archive files that include the image file containing an image included in the screen, and cause the terminal device

### CROSS-REFERENCE TO RELATED APPLICATIONS

This application is based on and claims the benefit of priority from Japanese Patent Application Serial No. 2014-062112 (filed on Mar. 25, 2014), the contents of which are hereby incorporated by reference in their entirety

### TECHNICAL FIELD

The present invention relates to a server and a method for displaying a screen, and in particular, to a server and a method for displaying a screen on a terminal device.

### BACKGROUND

Various digital contents such as games have recently been provided through web browsers performed on terminals such as smartphones. Such digital contents are provided with screens including various images displayed on the terminals. For example, when a screen to be displayed includes a plurality of images, a terminal device is required to obtain each of the images stored in a server so the number of requests for image files is increased. Consequently, it tends to take a long time to display such screen. In particular, when the sizes of the images contained in the screen are small, the time required for the increased number of requests largely affects the total time required to display the screen.

In order to avoid the increase of the number of requests, a technique called CSS sprites has been proposed (for example, see Japanese Patent Application Publication 2012-230675). According to this technique, a plurality of images to be displayed within the same screen is combined into a single sprite image and the sprite image is stored in a server. A terminal device acquires the sprite image from the server and then extracts the original images from the sprite image. Compared to the case where each of the images is obtained one by one, the number of requests sent to the server can be reduced by applying the CSS sprites.

Furthermore, in order to reduce the time required for displaying a screen including these images, data size of the image files are made smaller to reduce the time required for transfer and processing of the image file. For instance, to reduce the size of the image data, the number of colors can be reduced to the extent that the quality of the image is not largely affected.

Although the number of the requests sent to the sever can be reduced with the above-described CSS, the data size of the image cannot be sufficiently reduced with the reduction of the number of colors in some cases. More specifically, if distribution of colors accurately used in the images combined into a sprite image is largely different among the images, the color distribution in the sprite image spreads widely. Consequently, a compression rate of the data size that can be obtained by the reduction of the number of colors may be decreased compared to the case where the number of colors is reduced for each of the images. Therefore, it is desirable to realize a mechanism which can improve the compression rate of the data size of an image file while reducing the number of requests to a server.

### SUMMARY

One object of embodiments of the present invention is to increase the compression rate of data size of an image file while reducing the number of requests for obtaining a plurality of images contained in a screen. Other objects of the embodiments of the present disclosure will be apparent with reference to the entire description in this specification.

A server according to one embodiment of the present disclosure is a server for displaying a screen on a terminal device communicatively connected to the server. The server includes one or more physical processors configured to execute instructions. The one or more physical processors execute the instructions to implement a display control function by causing the terminal device, in response to a request to display the screen from the terminal device, to obtain an image file included in an archive file and to display the screen using the obtained image file, the archive file including a plurality of image files each of whose colors are reduced in advance to a predetermined number of colors or less, and the image file being obtained from one or more archive files that includes the image file corresponding to an image included in the screen.

A method according to one embodiment is a method for displaying a screen on a terminal device communicatively connected to one or more computers. The method includes, in response to a request to display the screen from the terminal device, causing the terminal device to obtain an image file included in an archive file and display the screen using the obtained image file by the one or more computers. The archive file includes a plurality of image files each of whose colors are reduced in advance to a predetermined number of colors or less, and the image file being obtained from one or more archive files including the image file corresponding to an image included in the screen.

According to various embodiments of the invention, it is possible to increase the compression rate of data size of an image file while reducing the number of requests for obtaining a plurality of images contained in a screen.

### BRIEF DESCRIPTION OF THE DRAWINGS

FIG. 1 is a block diagram schematically illustrating a network configuration of a system 1 including a server 10 according to an embodiment of the present invention.

FIG. 2 illustrates the content of an archive file 60 according to an embodiment.

FIG. 3 is a block diagram illustrating the functionality of the server 10 according to an embodiment.

FIG. 4 is a sequence diagram showing communication between the server 10 and the terminal device 30.

### DESCRIPTION OF THE PREFERRED EMBODIMENTS

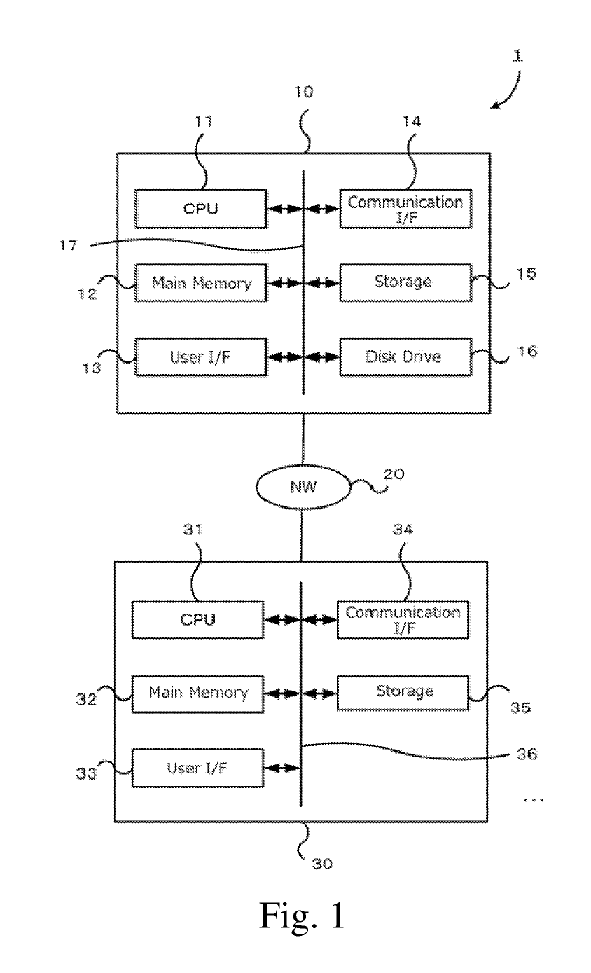

FIG. 1 is a block diagram schematically illustrating a network configuration of a system 1 including a server 10 according to an embodiment of the present invention. As shown in FIG. 1, the server 10 according to an embodiment may be communicatively connected via a communication network 20 such as the Internet to a plurality of terminals 30 configured as conventional computers and an archive server 40 (an archive file storage device) configured as a conventional computer; and the server 10 may provide various Internet services to the terminals 30 and cause the terminals 30 to display various screens used in the Internet services. The Internet services provided by the server 10 may include services for providing digital contents such as games, and platform services (SNS services) for implementing various communications between a plurality of users each operating a terminal device 30 (e.g., chat (MiniMail), circle, avatar, diary, message board, greeting, telephone call), but are not limited thereto.

As shown, the server 10 may include a central processing unit (CPU) (physical computer processor) 11, a main memory 12, a user interface (I/F) 13, a communication I/F 14, a storage 15, and a disk drive 16, and these components may be electrically connected to one another via a bus 17. The CPU 11 may load various programs into the main memory 12 from the storage 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminals 30 via the communication network 20.

The storage 15 may be formed of, for example, a magnetic disk drive and store various programs such as a control program for controlling the progress of various services provided by the server 10. The storage 15 may also store various data used in the various services. The various data that may be stored in the storage 15 may also be stored on a database server communicatively connected to the server 10 and physically separate from the server 10. The disk drive 16 may read data stored in storage medium such as a compact disc read only memory (CD-ROM), digital versatile disc read only memory (DVD-ROM), or DVD Recordable (DVD-R) disc, or write data to such a storage medium.

In an embodiment, the server 10 may function as a web server for managing a web site including a plurality of hierarchical web pages and may be capable of providing the terminal device 30 with various services via the web sites. The terminals 30 may fetch HTML data for rendering a web page (a screen) from the server 10 and analyze the HTML data to present the web page to a user of the terminals 30. For example, a game provided through such a web page is sometimes called a browser game. The storage 15 may also store the HTML data for rendering the web page. The HTML data may comprise HTML documents written in markup languages such as HTML; the HTML documents may be associated with various images. Additionally, the HTML documents may include programs written in various script languages.

The storage 15 may also store application programs (hereinafter also referred to as “applications”) to be executed on execution environments of the terminal device 30 other than browser software. These applications may include programs for performing various processes and various data such as image files to be referred to for executing the programs. The programs may be created in, for example, object oriented languages such as Objective-C™ and Java™. The application stored on the storage 15 may be delivered to the terminal device 30 in response to a delivery request. The application delivered from the server 10 may be received by the terminal device 30 through a communication I/F 34 in accordance with the control of CPU 31; and the received application may be stored in a storage 35. The application may be launched in accordance with the user's operation on the terminal device 30 and may be executed on an execution environment implemented on the terminal device 30 such as ngCore™ or Android™. The server 10 may provide the applications executed on the terminals 30 with various necessary data. Additionally, the server 10 can store various data sent from the terminal device 30 for each user, thereby managing the statuses of the various services such as progress of games for each user.

Thus, the server 10 may manage the web site for providing various services and deliver web pages constituting the web site in response to a request from the terminal device 30, thereby providing various services. Also, the server 10 can provide various services based on communication with an application performed on the terminal device 30 in place of, or in addition to, such browser-based services. Briefly, the server 10 may also include a function to authenticate a user at start of various services and perform charging process in accordance with provision of various services.

In an embodiment, the terminal device 30 may be any information processing device that may display on a web browser a web page of a web site obtained from the server 10 and include an application executing environment for executing applications; and the terminals 30 may include personal computers, smartphones, tablet terminals, and game-dedicated terminals.

As shown, the terminal device 30 may include a central processing unit (CPU) (physical computer processor) 31, a main memory 32, a user interface (I/F) 33, a communication I/F 34, and a storage 35, and these components may be electrically connected to one another via a bus 36.

The CPU 31 may load various programs into the main memory 32 from the storage 35, and may execute commands included in the loaded programs. The main memory 32 may be used to store a program to be executed by the CPU 31, and may be formed of, for example, a dynamic random access memory (DRAM).

The user I/F 33 may include an information input device for receiving user inputs and an information output device for outputting an operation result of CPU 31; and the user I/F may include a display device such as a liquid crystal display having a touch panel.

The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20.

The storage 35 may be constituted by, for example, a magnetic disk drive or a flash memory and store various programs such as an operating system and an application program and various data processed by these programs. The storage 35 may include a built-in storage and a removable storage. A removable storage may include, for example, an SD memory card having a built-in flash memory.

The terminal device 30 having such architecture may include, for example, browser software for interpreting HTML data and rendering a screen; this browser software may enable the terminal device 30 to interpret the HTML data fetched from the server 10 and render web pages corresponding to the received HTML data. Further, the terminal device 30 may include plug-in software embedded into browser software; therefore, the terminal device 30 can fetch from the server 10 or another server a SWF file embedded in HTML data and execute the SWF file by using the browser software and the plug-in software.

When browser software or an application program is executed on the terminal device 30, for example, animation or an operation icon designated by the program may be displayed on the terminal device 30. A user can input various instructions via a user I/F 33 of the terminal device 30. The instruction entered by the user may be transmitted to the server 10 through the browser of the terminal device 30 or a function of an execution environment such as ngCore™

At least part of the plurality of application programs executed on the terminal device 30 may have a region (WebView region) for rendering a screen corresponding to a web page based on interpreted HTML data, and the region may be located in at least part of a screen region displayed on the terminal device 30. Application programs having the WebView region may make a request to the server 10 for rendering the WebView region and may render the other regions of the screen on the terminal device 30.

The archive server 40 may be configured as a conventional computer that includes a CPU, a main memory, storage and the like. The archive server 40 stores more than one archive file. The image files corresponding to images contained in various screens used in the Internet services provided by the server 10 are combined into one archive file. In an embodiment, the archive server 40 may belong to a domain different from a domain to which the server 10 belongs.

An archive file stored in the archive server 40 will be now described. In an embodiment, a plurality of image files corresponding to images on various screens are combined into one archive file. The number of colors used in each of the plurality of the image file may be in advance reduced to a predetermined number of colors (for example, 256 colors, 65,536 colors or the like) or less. Such color reduction (color quantization process) can be performed by various algorithms including median cut. For instance, a set (pallet) of colors that includes the number of colors smaller than colors used in an original image may be created based on a distribution of the colors actually used in the original image before the color reduction. The pallet may be created such that the quality of the image is less affected by the color reduction. The colors of the original image are converted using this pallet. Since such process and algorithm for color reduction is conventional to those skilled in the art, further detailed description thereof will be omitted.

In one embodiment, image files required for displaying one display object, among various display objects (which may include various screen components such as characters, items, menus, backgrounds and the like), may be packed into one archive file. For instance, image files required for displays a single character, such as an image file of a face of the character, an image file of arms of the character, and an image file of legs of the character are packed into one archive file.

In one embodiment, the archive file may be further converted into text data by performing a prescribed conversion process (for example, BASE64 conversion process) onto each of the image files packed in the archive file. The text data after conversion (hereunder may be referred to as “image conversion data”) may be written in a JSON format.

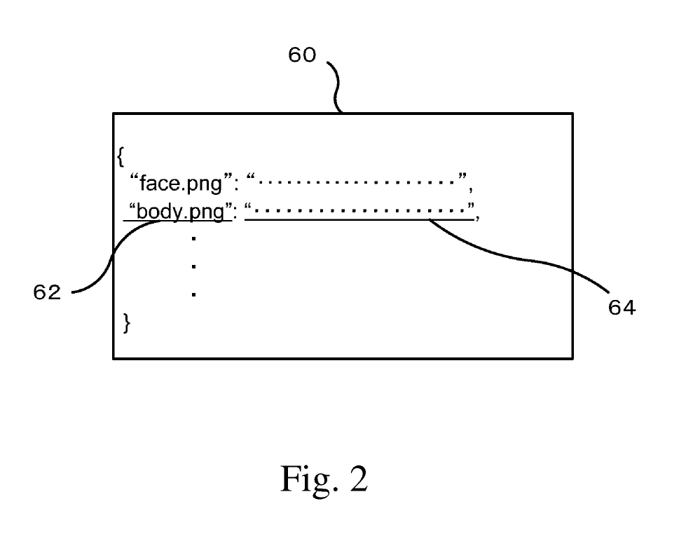

FIG. 2 illustrates an example of the content of the archive file according to an embodiment. An archive file 60 may include a combination of a name 62 and a value 64 in a JSON format as shown in FIG. 2. A name of an image file is written in the name 62 and the content of the above-described image conversion data (text data) is written in the value 64.

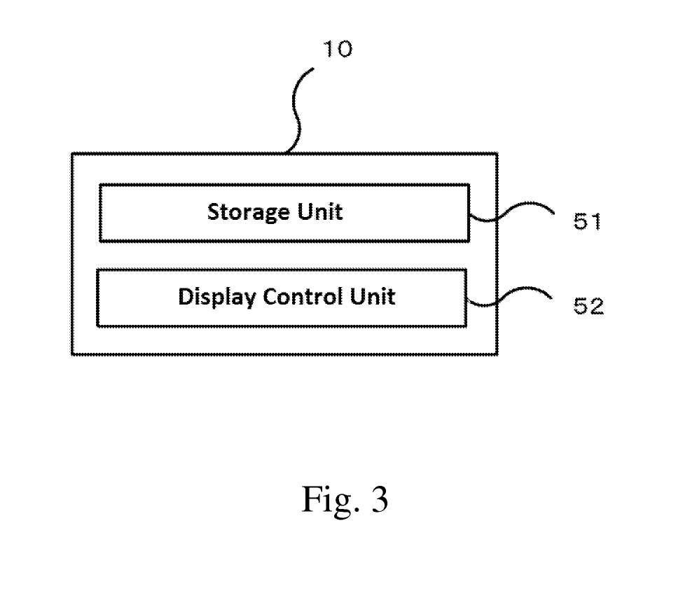

Next, functionality of the server 10 according to an embodiment will be described. FIG. 3 is a block diagram illustrating the functionality of the server 10 according to an embodiment. The server 10 according to the embodiment may include a storage unit 51 configured to store information, and a display control unit 52 configured to, in response to a display request to display a screen from the terminal device 30, cause the terminal device 30 to obtain an image file from one or more archive files that include the image file containing an image included in the screen, and cause the terminal device 30 to display the screen using the obtained image file. The above functionality may be implemented by cooperation between CPU 11 and various programs and tables stored on main memory 12 and storage 15. An example of such cooperation may be execution of instructions included in a loaded program by CPU 11. The storage unit 51 according to an embodiment may be realized as storage 15 and the like and various programs, HTML data and the like describe above may be stored thereon.

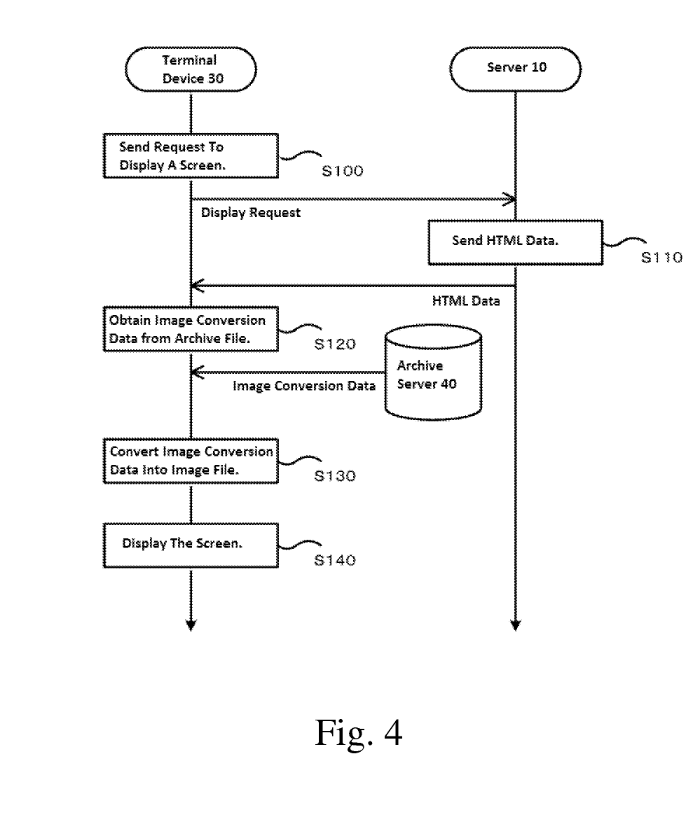

Next, operations of such a server 10 according to an embodiment will now be described. FIG. 4 is a sequence diagram showing communication between the server 10 and the terminal device 30 when the server 10 causes the terminal device 30 to display a screen according to an embodiment. When the terminal device 30 is caused to display a screen, a display request to display a screen may be firstly sent from the terminal device 30 to the server 10 (step S100). For example, the terminal device 30 may make a request to the server 10 through a web browser for displaying screens used in various Internet services provided by the server 10. The server 10 may receive the display request from the terminal device 30 and then send HTML data that corresponds to the screen of the display request to the terminal device 30 (step S110). The HTML data may be stored in the storage 15 and the like of the server 10 as described above or may be dynamically generated by using CGI or the like.

After the terminal device 30 receives the HTML data from the server 10, the terminal device 30 may interpret the HTML data and then obtain, from the archive file stored in the archive server 40, the above-described image conversion data of the image file corresponding to the image included in the screen (step S120). In one embodiment, obtaining the image conversion data from the archive file may be performed by using JSONP (JSON with padding). More specifically, in a <script> element in the HTML data sent from the server 10, the archive file stored in the archive server 40 may be specified as URI and a callback function may be specified by using a query parameter such as “callback.” After the web browser of the terminal device 30 interprets the HTML data, the terminal device 30 requests the image conversion data written in the JSON format to the archive server 40. In response to the request, the archive server 40 may send to the terminal 30 a code of JavaScript™ to call the callback function that includes the image conversion data as a parameter. Once the callback function is called on the web browser of the terminal device 30, the terminal device 30 may be able to handle the image conversion data. In this manner, the terminal device 30 can obtain data stored in the archive server 40 belonging to a domain different from the domain to which the server 10 belongs by applying the JSONP using the <script> element of HTML that can specify an URI of another domain. Since such operation of the JSONP is conventional to those skilled in the art, further detailed description will be omitted

Here, the archive file specified in the HTML data sent from the server 10 may include the image file corresponding to the image included in the screen of the display request. The archive file includes a plurality of image files required for displaying a single display object included in the screen as described above. Thus, in the HTML data sent from the server 10, more than one archive file may be specified corresponding to each of the display objects included in the screen of the display request respectively, and the terminal device 30 may obtain image conversion data from each of the archive files.

Once the image conversion data is obtained by the terminal device 30, the image conversion data may be converted (BASE64 reverse conversion) into an image file (step S130), and this image file may be used to display the screen (step S140) on the terminal device 30. When the image conversion data is converted into the image file, image conversion data corresponding to images included in the screen to be displayed may be specified and only the specified image conversion data may be converted into the image file. When the converted image file is a compressed image file compressed in a PNG format or the like, the compressed image file may be decompressed by the terminal device 30 and the decompressed image data may be stored in the main memory 32 or the like. By decompressing only the necessary image conversion data into the image data, a memory capacity required for storing the image data can be reduced compared to the case where the image data of all the images included in a single sprite image (a single image file) are decompressed and stored into a main memory or the like. Since such process of displaying a screen using image files are conventional, further detailed description will be omitted. By repeating this process of displaying a screen on the terminal device 30 in the above-described manner in response to the display request from the terminal device 30, it is possible to display various screens including a video (animation) on the terminal device 30.

According to the embodiment described above, the server 10 may cause the terminal device 30, in response to a request to display a screen from the terminal device 30, to obtain an image file included in an archive file. The archive file includes a plurality of image files each of whose colors are reduced to a predetermined number of colors or less. The terminal device 30 obtains the image file from one or more archive files that include the image file corresponding to the image on the screen. Therefore, the number of requests from the terminal device 30 can be reduced compared to the case where each of the image files is obtained one by one. Moreover, since the colors of each image file included in the archive file are reduced to the predetermined number of colors or less, it is possible to increase the compression rate of data size of the image file compared to the case where a plurality of images are combined into a single image such as CSS sprites or the like.

Moreover, in the server 10 according to an embodiment, the archive file may include image conversion data written in the JSON format, and the server 10 may cause the terminal device 30 to obtain the image conversion data by using the JSONP. Therefore, it is possible for the terminal device 30 to obtain the image conversion file from the archive file in the archive server 40 belonging to a domain different from a domain where the server 10 belongs to (it is possible to obtain an image file (image conversion data) by using a cross-domain communication). The server 10 sends the HTML data corresponding to the screen.

Moreover, according to an embodiment, one archive file may be configured to include a plurality of image files required for displaying one display object (in other words, the archive file is created for each display object). Therefore, the plurality of image files included in the archive file are used for displaying the same display object so that it is possible to cut the time needed for transfer or processing of an archive file (image conversion data) that includes unnecessary image files.

Moreover, according to an embodiment, because the image conversion data is stored in the archive server 40, it is possible to reduce the time required for receiving (downloading) the HTML data and CSS compared to the case where the image conversion data is embedded in the HTML data and CSS (for example, the image conversion data can be embedded by using a Data URI scheme). Consequently, layout process of a web page can be completed more quickly. In other words, usually, to complete the layout process of a web page, downloading of HTML data and CSS has to be completed. In addition, when data such as image conversion data is embedded in HTML data or CSS, the data size of the HTML data or CSS is increased and it may take a longer time to download it. As a result, it may take longer time to complete the above-described layout process. Whereas according to the embodiment, the image conversion data is not embedded in the HTML data and CSS so that it may take a shorter time to download it and consequently it is possible to complete the above-described layout process quickly and thereafter perform acquisition, conversion and the like of the image conversion data. As described above, according to the embodiment, it is possible to reduce the time required for completion of the layout process and the time required for transfer of the image file (image conversion data) by using the image file compressed with a high compression rate.

In the above-described embodiment, the image conversion data of the image file in the archive file is written in the JSON format, and the terminal device 30 obtains the image conversion data by using the JSONP. However, the format of the archive file is not limited and archive files in various formats can be used to obtain a plurality of image files included in the archive file. Moreover, the terminal device 30 can obtain the image file included in the archive file in various manners.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

1. A server for displaying a screen on a terminal device communicatively connected to the server, comprising:
one or more physical processors configured to execute instructions, wherein
the one or more physical processors execute the instructions to implement a display control function by causing the terminal device, in response to a request to display the screen from the terminal device, to obtain an image file included in an archive file and to display the screen by using the obtained image file, the archive file including a plurality of image files each of whose colors are reduced in advance to a predetermined number of colors or less, and the image file being obtained from one or more archive files including the image file corresponding to an image included in the screen,
the screen is configured to be a part of a motion picture shown by repeatedly performing display of a screen,
the archive file is created for each display object included in the screen and includes a plurality of the image files required for displaying the single display object.

2. The server of claim 1, wherein the display control function causes the terminal device to obtain, from the archive file stored in an archive file storage device storing a plurality of the archive files, an image file included in the archive file.

3. The server of claim 2, wherein the archive file storage device belongs to a domain different from a domain to which the server belongs, the archive file includes more than one piece of image conversion data written in a JSON format, the image conversion data is text data converted from each of the plurality of image files included in the archive file by a predetermined conversion process, the display control function causes the terminal device to obtain, from the archive file stored in the archive file storage device, the image conversion data included in the archive file by using JSONP, convert the image conversion data into the image file, and display the screen by using the converted image file.

4. The server of claim 3, wherein the predetermined conversion process is a BASE64 conversion process.

5. (canceled)

6. A method for displaying a screen on a terminal device communicatively connected to one or more computers, comprising:
in response to a request to display the screen from the terminal device, causing the terminal device to obtain an image file included in an archive file and display the screen by using the obtained image file by the one more computers, wherein
the archive file includes a plurality of image files each of whose colors are reduced in advance to a predetermined number of colors or less, and the image file being obtained from one or more archive files including the image file corresponding to an image included in the screen,
the screen is configured to be a part of a motion picture shown by repeatedly performing display of a screen,
the archive file is created for each display object included in the screen and includes a plurality of the image files required for displaying the single display object.
